(19) United States
(12) Patent Application Publication
(10) Pub. No.: US 2006/0022914 A1
(43) Pub. Date: Feb. 2, 2006

(54) Driving circuit and method for display panel

(75) Inventors: Naoya Kimura, Chiba (JP); Tetsuro Hara, Tokyo (JP); Akira Kondo, Fukuoka (JP); Takayuki Shimizu, Tokyo (JP); Haruyo Takayanagi, Chiba (JP); Shinichi Fukuzako, Kanagawa (JP); Ichirou Takayama, Ibaraki (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/194,771

(22) Filed: Aug. 2, 2005

(30) Foreign Application Priority Data
Aug. 2, 2004 (JP) 2004-226106

(51) Int. Cl. G09G 3/30

(52) U.S. Cl. 345/76

(57) ABSTRACT

A driving circuit drives a display panel having a matrix of picture elements and electrodes. The driving circuit includes a memory storing compensation data for compensating for position-dependent brightness differences between the picture elements. The brightness differences are due to the stray resistance and capacitance of the picture elements and electrodes. A correction circuit modifies image data according to the compensation data to generate control signals, which are used to control drivers that drive the picture elements via the electrodes. The modified image data produce a display with an even average brightness over the entire display panel.

### BACKGROUND OF THE INVENTION

1. Field of the Invention

The present invention relates to a driving circuit for driving a display panel such as a liquid crystal panel or an organic electroluminescence (EL) panel.

2. Description of the Related. Art

Japanese Patent Application Publication No. 2004-45702 proposes improving the image reproducibility of a liquid crystal display by modifying the input image signal. The display device has a liquid crystal panel and a reference table storing corrections to be added to the value of a picture element (pixel) in the input signal. The correction values are obtained by adding a correction for the color reproducibility of the liquid crystal panel to a driving overshoot correction that compensates for the optical response of the liquid crystal panel. The total correction depends on the value of the pixel in the current frame and one frame before. The table is addressed according to these two pixel values, the correction is added to the value of the pixel in the current frame, and the corrected pixel value is sent to the liquid crystal panel.

This scheme reproduces colors and brightness gradations accurately and prevents afterimages, but it leaves unsolved the problem of position-dependent differences in pixel response due to the resistance and capacitance of the row lines (row electrodes) and column lines (column electrodes) in the display panel. Because of this problem, pixels respond differently to the same driving conditions depending on where they are located on the panel surface, particularly in a high-resolution display panel.

The resolution of a display can be increased by increasing the display area or the pixel density. Since the pixels are disposed at the intersections of the row and column lines and are driven by signals applied through these lines, if the display area is increased, differences in the length of the row and column lines from the line drivers to the pixel position become pronounced. If the pixel density is increased, the row and column lines are narrowed, so their electric resistance increases. Both cases lead to increased differences in line resistance depending on pixel position. As the number of pixels per row or column line also increases, the stray capacitance of the row and column lines due to the pixel capacitance likewise increases, leading to increased differences in line capacitance depending on pixel position. Because of these position-dependent differences in resistance and capacitance, if pixels in different positions are driven by the same driving signal, the same brightness is not obtained. In a color display, color reproducibility also deteriorates because of brightness differences between the three primaries (red, green, and blue).

### SUMMARY OF THE INVENTION

An object of the present invention is to provide a display panel driving circuit that can compensate for brightness differences between picture elements caused by differing electrical resistance and capacitance on row and column lines, and display an image with the same brightness scale at all pixel positions.

The invented driving circuit drives a display panel having a matrix of picture elements. The driving circuit includes a memory storing compensation data for compensating for brightness differences between the picture elements. A correction circuit receives image data, modifies the image data according to the compensation data, and generates control signals from the modified image data. A plurality of drivers drive the picture elements according to the control signals.

Typically, the display panel has a plurality of first electrodes (e.g., column electrodes) that are driven substantially simultaneously according to the modified image data, and a plurality of second electrodes (e.g., row electrodes) that are driven sequentially in a repeated scanning sequence. The picture elements are located at the intersections of the first and second electrodes.

In one preferred embodiment, the compensation data compensate for brightness differences on a per-pixel basis. In this embodiment, the compensation process includes the steps of:
prestoring one compensation value for each picture element in a memory;
modifying image data to be displayed on the display panel according to the prestored compensation values;
generating control signals from the modified image data; and
driving the first electrodes according to the control signals.

In another preferred embodiment, the compensation data include first compensation data that compensate for brightness differences between different first electrodes, and second compensation data that compensate for brightness differences between different second electrodes. In this embodiment, the compensation process includes the steps of:
prestoring one compensation value for each first electrode in a first memory;
prestoring one compensation value for each second electrode in a second memory;
modifying image data to be displayed on the display panel according to the compensation values prestored in the first memory;
generating first control signals from the modified image data;
driving the first electrodes according to the first control signals; and
driving the second electrodes according to the compensation values stored in the second memory.

### BRIEF DESCRIPTION OF THE DRAWINGS

In the attached drawings:

FIG. 1 is a block diagram showing a driving circuit and display panel according to a first embodiment of the invention;

FIG. 2 is a timing waveform diagram showing an example of the operation of the driving circuit shown in FIG. 1; and

FIG. 3 is a block diagram showing a driving circuit and display panel according to a second embodiment of the invention.

### DETAILED DESCRIPTION OF THE INVENTION

Embodiments of the invention will now be described with reference to the attached drawings, in which like elements are indicated by like reference characters.

### First Embodiment

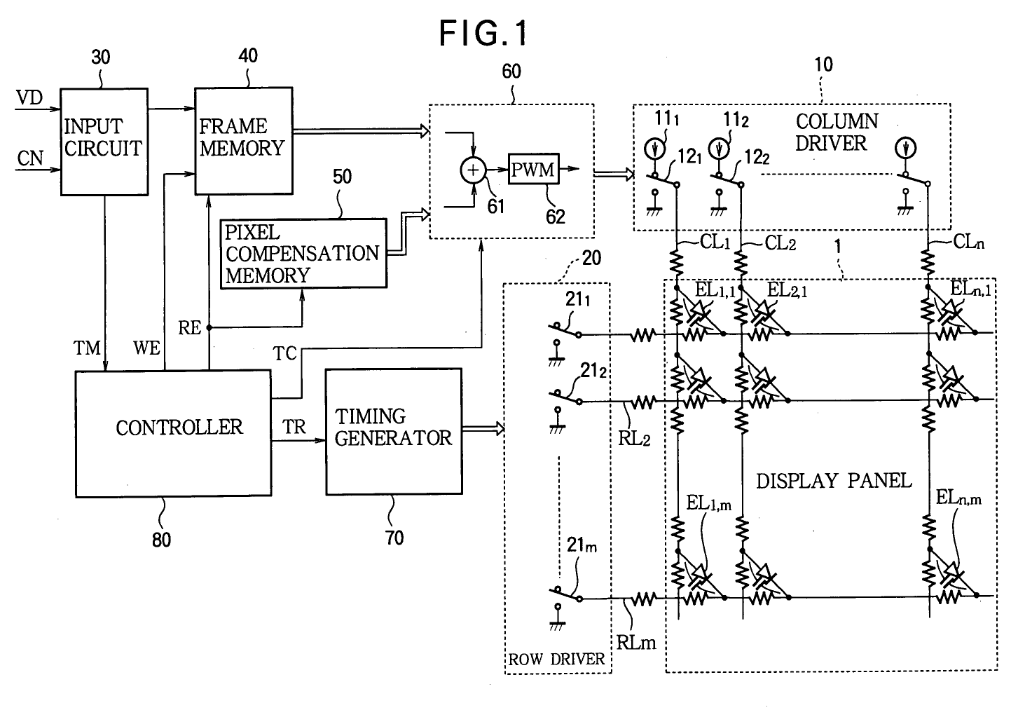

Referring to FIG. 1, the display panel driving circuit in the first embodiment has a column driver 10 and a row driver 20 that drive a display panel 1. The display panel 1 is, for example, an organic electroluminescence panel having an orthogonal grid of equally spaced horizontal row lines RLⱼ (j=1 to m) and equally spaced vertical column lines CLᵢ (i=1 to n), with electroluminescent elements EL_{i,j} (also referred to as organic light-emitting diodes or OLEDs) disposed at the intersections of the column lines CLᵢ and row lines RLⱼ.

The row lines RLᵢ and column lines CLᵢ have a distributed resistance component indicated by resistor symbols in the drawing. A static capacitance, indicated by capacitor symbols in the drawing, is present between each row line RLⱼ and column line CLᵢ at the electroluminescent element EL_{i,j} where these lines intersect. The farther an electroluminescent element EL_{i,j} is from the column driver 10 and row driver 20, the more it is affected by these stray resistance and capacitance components. (The resistor and capacitor symbols do not represent discrete circuit elements.)

In the display panel 1, when a row line RLⱼ is selected by being connected to ground (row line RL₁ is so selected in the drawing), each electroluminescent element EL_{i,j} in the selected row RLⱼ is driven by current supplied from the column lines CLᵢ, and emits light with a brightness depending on the amount of driving current supplied. In this embodiment, the amount of current depends on the length of time for which the current is supplied.

The column driver 10 comprises constant current sources 11ᵢ and switches 12ᵢ connected to the corresponding column lines CLᵢ. The switches 12ᵢ are switched on and off according to control signals having pulse widths corresponding to the desired brightness gradations of the electroluminescent elements EL_{i,j}.

The row driver 20 drives the row lines RLⱼ sequentially in a repeated scanning sequence (running downward in the drawing) by connecting the row lines RLⱼ, one by one, to the ground level. The row driver 20 comprises a plurality of switches 21ⱼ that are switched on and off according to control signals (not shown) so as to form a short or open circuit between each row line RLⱼ and ground.

The display panel driving circuit further comprises: an input circuit 30 that receives an image signal VD to be displayed; a frame memory 40 that stores image data; a pixel compensation memory 50 that stores compensation data for compensating for brightness differences in the display panel 1 on a per-pixel basis; compensation circuits 60 that modify the image data and generate control signals for the column driver 10; a timing generator 70 that generates control signals for the row driver 20; and a controller 80 that controls an entire system by generating control signals for the frame memory 40, pixel compensation memory 50, compensation circuits 60, and timing generator 70.

The input circuit 30 receives the image signal VD to be displayed together with a control signal CN, sends the data in the image signal VD to the frame memory 40, generates a timing signal TM, and sends the timing signal TM to the controller 80. The frame memory 40 stores one frame of image data by storing the image data VD received from the input circuit 30 according to a write enable signal WE supplied from the controller 80, and sends successive lines of stored image data to the compensation circuits 60. The stored lines of image data correspond to the row lines RLⱼ, and are output one at a time according to a read enable signal RE supplied from the controller 80.

The pixel compensation memory 50 is, for example, a read-only memory (ROM) that stores one compensation value for each electroluminescent element EL_{i,j}. The compensation data stored in the pixel compensation memory 50 are determined from factory tests of the display panel 1. The values of the compensation data are chosen so as to obtain a uniform brightness scale over the entire display panel. In one scheme, all the electroluminescent elements EL_{i,j} are driven with a uniform driving time, the brightness of each pixel is measured, the average brightness is taken as a reference value, and for each pixel, an individual compensation value is calculated and stored in the pixel compensation memory 50. Positive compensation values are stored for pixels having less than the average brightness; negative compensation values are stored for pixels having more than the average brightness; zero compensation values are stored for pixels whose measured brightness equals the average brightness.

The compensation data in the pixel compensation memory 50 are read out line by line in correspondence to lines of image data read from the frame memory 40, in response to the read enable signal RE supplied from the controller 80, and are supplied to the compensation circuits 60.

Using the lines compensation data output from the pixel compensation memory 50, the compensation circuits 60 modify the lines of image data read from the frame memory 40 on a per-pixel basis, operating according to a column timing signal TC supplied from the controller 80. The compensation circuits 60 are connected to respective column lines CLᵢ. Each compensation circuit 60 comprises an adder 61 that adds the compensation data to the image data, and a pulse width modulator (PWM) 62 that generates a control signal with a pulse width determined according to the sum received from the adder 61. A negative compensation value reduces the pulse width, while a positive compensation value increases the pulse width. The control signals for the column lines, generated by the pulse width modulators 62, are supplied to the switches 12ᵢ in the column driver 10.

The timing generator 70, operating according to a row timing signal TR supplied from the controller 80, generates control signals by which the switches 21ⱼ in the row driver 20 sequentially connect the row lines RLⱼ, one at a time, to the ground voltage level.

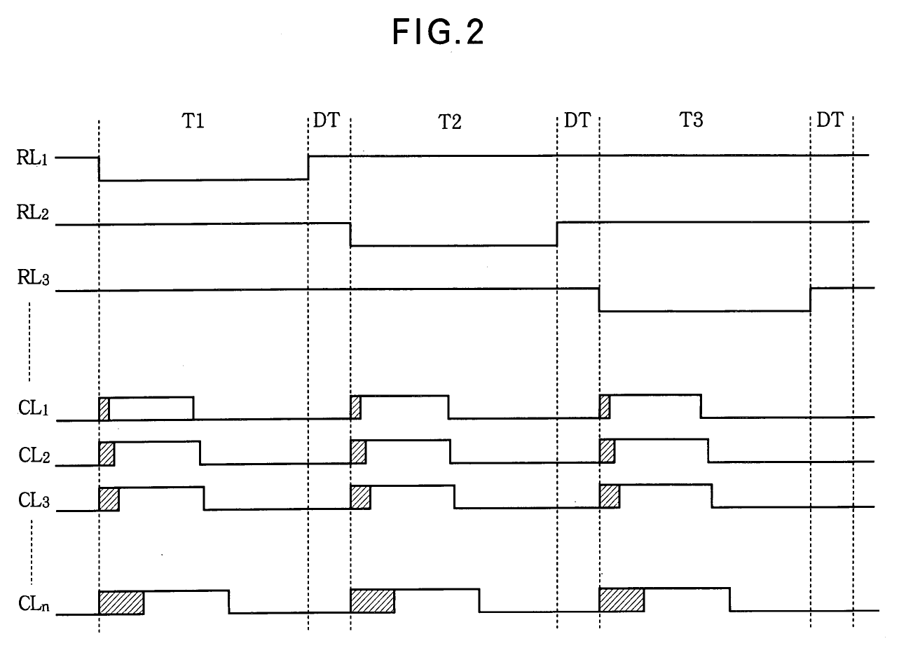

Next, the operation of the circuit shown in FIG. 1 will be described with reference to the exemplary timing diagram in FIG. 2.

The image data signal VD is received by the input circuit 30 together with the externally supplied control signal CN. An entire frame of image data is stored in the frame memory 40 in synchronization with the write enable signal WE supplied from the controller 80.

The timing generator 70 now generates control signals for driving the first row line RL₁ according to the row timing signal TR supplied from the controller 80. These control signals turn on switch 21₁, in the row driver 20 so that row line RL₁ goes to the ground voltage level, and turn off all the other switches 21₂ to 21ₘ so that row lines RL₂ to RLₘ are placed in an electrically open state.

In the meantime, in response to the read enable signal RE supplied from the controller 80, the first line of image data stored in the frame memory 40 and the first line of compensation data stored in the pixel compensation memory 50 are read out and supplied to the compensation circuits 60. The compensation circuits 60 add the image data to the corresponding compensation data, and generate column control signals having pulse widths determined from the resulting sums. The column control signals generated in the compensation circuits 60 are supplied to the corresponding switches 12ᵢ in the column driver 10. Each switch 12ᵢ is turned on for a time depending on the pulse width of the corresponding column control signal. The driving operations for the first row take place during period T1 in FIG. 2.

While the switches 12ᵢ are turned on, constant currents flow from the constant current sources 11ᵢ in the column driver 10 to ground via the switches 12ᵢ, column lines CLᵢ, electroluminescent elements EL_{1,j}, and row line RL₁. Since the stray resistance and capacitance on this current path differs for each column line CLᵢ, each electroluminescent element EL_{1,j} has a different response time. More specifically, the current flow rises more slowly with increasing distance from the switch 21₁, due to the increasing length of the current path on the first row line RL₁. Because of the compensation data, however, even if the image data values are the same for all pixels, the driving current waveforms differ as shown in FIG. 2. The hatching in FIG. 2 indicates the differing amounts of compensation added to the driving times. For the sake of clarity, all of the compensation times are shown as having positive values. The compensation time increases from the first column (CL₁) to the last column (CLₙ) to compensate for the increasing rise time of the driving current.

Each switch 12ᵢ in the column driver 10 is turned off after the duration of the corresponding control signal pulse. The increasing amounts of compensation added to the driving times in successive columns produce a uniform brightness scale over the entire row, so that if, for example, all of the pixels have identical image data, all electroluminescent elements in the first row emit light with equal brightness.

After the driving of the first row, a discharge time DT is inserted as shown in FIG. 2, the image data for the second row are read out, compensation is added, and the electroluminescent elements EL_{2,j} in the second row are driven according to the compensated image data during period T2. These operations are similar to the operations for the first row, and take place according to the read enable signal RE and timing signals TC, TR output from the controller 80. The compensation values (indicated by hatching) added to the driving times are in general slightly larger than in the first row, to compensate for increased stray resistance and capacitance on the column lines, which further delay the rise of the driving current.

Driving of the third and following rows continues in the same way in period T3 and subsequent periods, the compensation values tending to increase slightly in each successive row.

The pixel compensation memory 50 and compensation circuit 60 in the display panel driving circuit in the first embodiment compensate for brightness differences in the display panel 1 so as to obtain a uniform brightness scale: the pixel compensation memory 50 stores compensation data used to modify the driving times for each pixel, and the compensation circuit 60 generates control signals from the compensation data and the image data. Brightness differences caused by stray resistance and capacitance differences on the row and column lines of the display panel 1 are thereby compensated for and a uniform brightness scale is obtained.

The first embodiment can be modified in various ways, including, for example, the following:
(a) The display panel 1 need not be an organic electroluminescence panel; it may be a liquid crystal display panel or any other flat display panel of the matrix display type.
(b) Depending on the type of driving circuit employed in the column driver 10, the compensation data in the pixel compensation memory 50 may be used to modify the driving current or driving voltage instead of modifying the driving time, with corresponding changes in the structure of the compensation circuits 60. For example, the pulse-width modulators may be replaced by digital-to-analog converters.
(c) The compensation data need not be referenced to the average pixel brightness. For example, the compensation data may be referenced to the brightest pixel, in which case all compensation values are positive.

### Second Embodiment

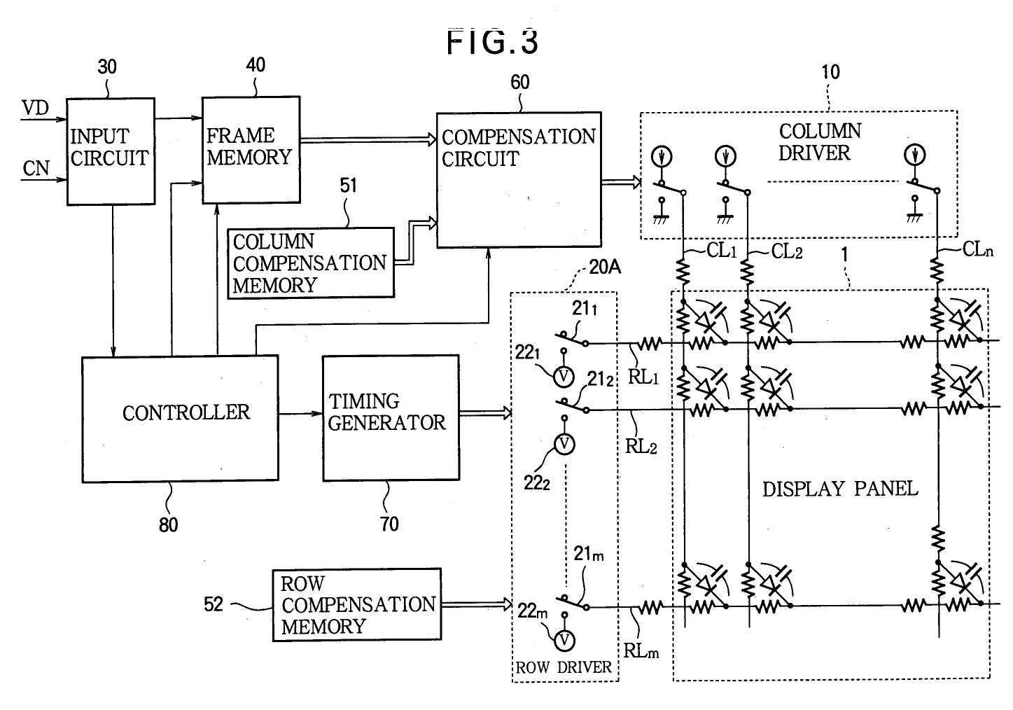

Referring to FIG. 3, the display panel driving circuit in the second embodiment has a column compensation memory 51 and row compensation memory 52 in place of the pixel compensation memory 50 in FIG. 1. The structure and function of the row driver 20A are also modified.

The column compensation memory 51 stores compensation data for compensating for brightness differences caused by stray resistance and capacitance on the row lines RLⱼ. These differences appear as brightness differences between different column lines CLᵢ, but are substantially the same for every row line RLⱼ. Accordingly, whereas the pixel compensation memory 50 in the first embodiment stores one compensation value for each pixel, the column compensation memory 51 in the second embodiment stores only one compensation value for each column line CLᵢ. The size of the column compensation memory 51 is accordingly less than the size of the pixel compensation memory 50.

The row driver 20A includes the same switches 21ⱼ as in the first embodiment, but also includes variable voltage sources 22ⱼ that can provide different voltages to different row lines RLⱼ. The row compensation memory 52 stores compensation data that control the variable voltage sources 22ⱼ. One value is stored for each row.

The compensation data stored in the column compensation memory 51 and row compensation memory 52 are determined by performing tests in advance on the display panel 1 so as to obtain a substantially uniform brightness scale over the entire surface of the display panel 1. In one scheme, the average pixel brightness in each row and the average pixel brightness in each column are determined under uniform driving conditions, and the compensation data are calculated so as to equalize all of these average pixel brightnesses.

Other structures in the second embodiment are the same as in FIG. 1.

Next, the operation of the second embodiment will be described.

The image data signal VD is input to the input circuit 30 together with the externally supplied control signal CN. One frame of image data is stored in the frame memory 40 according to the write enable signal WE supplied from the controller 80.

Next, in response to the read enable signal RE supplied from the controller 80, the first line of image data stored in the frame memory 40 is read out and supplied to the compensation circuits 60, which add the corresponding compensation values stored in the column compensation memory 51 and generate control signals having pulse widths determined by the resulting sums. The control signals are supplied to the corresponding switches 12ᵢ in the column driver 10, each of which is turned on for a time depending on the pulse width of the corresponding control signal.

In the meantime, the timing generator 70, operating according to the row timing signal TR supplied from the controller 80, generates the control signals for driving the first row line RL₁. Switch 21₁ in the row driver 20A is thereby turned on so that row line RL₁ is connected to variable voltage source 22₁, while the other switches 22₂ to 22ₘ are turned off.

Currents now flow from the constant current sources 11ᵢ in the column driver 10 to the variable voltage source 22₁ via the switches 12ᵢ, column lines CLᵢ, electroluminescent elements EL_{1,j}, and row line RL₁. The compensation data stored in the column compensation memory 51 compensate for column-to-column differences in the stray resistance and capacitance on row line RL₁ to produce a uniform brightness scale over the entire row.

Each switch 12ᵢ in the column driver 10 is turned off after the duration of the corresponding control signal pulse. Next, the image data for the second line are read from the frame memory 40, and the electroluminescent elements EL_{2,j} connected to the second row line RL₂ are similarly driven. The compensation data supplied to the compensation circuits 60 are the same as in the first row, since the stray resistance and capacitance on the second row line RL₂ are substantially the same as on the first row line RL₁, but the compensation value supplied from the row compensation memory 52 to the row driver 20A differs. The differing compensation value compensates for the additional stray resistance and capacitance on the column lines CLᵢ as seen from the second row line RL₂ instead of the first row line RL₁. Due to the different compensation value, the voltage supplied to row line RL₂ from variable voltage source 22₂ differs slightly from the voltage supplied to row line RL₁ from variable voltage source 22₁.

Operation continues in this way as subsequent rows are driven, the same column compensation data being used in each row, the row compensation data varying from row to row.

As a result of the two types of compensation, the brightness scale remains substantially uniform over the entire area of the display panel 1. Compared with the first embodiment, however, it is only necessary to store one compensation value for each column and one compensation value for each row, instead of one compensation value for each pixel. The total number of stored compensation values is accordingly (m+n) instead of (m×n). For typical values of m and n, this amounts to a substantial reduction in the amount of compensation data that must be prepared and stored.

The second embodiment can also be modified in various ways, including, for example, the following:
(a) If column-to-column differences in brightness scale are negligible, the column compensation memory 51 and compensation circuits 60 may be eliminated and the second embodiment may operate using only the row compensation memory 52 and row driver 20A to compensate for row-to-row differences.
(b) Conversely, if row-to-row differences in the brightness scale are negligible, the row compensation memory 52 may be eliminated, the row driver 20A may be replaced with the simpler structure shown in FIG. 1, and the second embodiment may operate using only the column compensation memory 51 and compensation circuits 60 to compensate for column-to-column differences.
(c) The compensation data in the column compensation memory 51 may be used to modify driving currents or driving voltages instead of driving times, with suitable changes in the structure of the compensation circuits 60.
(d) The compensation data in the row compensation memory 52 may used to control driving times instead of controlling the voltages supplied to the row lines RLⱼ. In FIG. 2, the fall of the driving waveforms for rows RL₁, RL₂, RL₃, . . . are delayed by successively decreasing amounts from the rise of the driving waveforms for columns, . . . . Alternatively, the compensation data read from the row compensation memory 52 may be supplied to the compensation circuits 60, and the row driver 20A may have the simpler structure shown in FIG. 1. The compensation circuits 60 then modify the value of each pixel by adding both the compensation value for the corresponding column and the compensation value for the corresponding row, obtained respectively from the column compensation memory 51 and the row compensation memory 52.

Those skilled in the art will recognize that further modifications of both the first and second embodiments are possible within the scope of invention, which is defined by the appended claims.

What is claimed is:

1. A driving circuit for driving a display panel having a matrix of picture elements, comprising:
a memory storing compensation data for compensating for brightness differences between the picture elements;
a correction circuit for receiving image data, modifying the image data according to the compensation data, and generating control signals from the modified image data; and
a plurality of drivers for driving the picture elements according to the control signals.

2. The driving circuit of claim 1, wherein the display panel has a first plurality of first electrodes and a second plurality of second electrodes intersecting the first electrodes, the picture elements being disposed at respective intersections of the first electrodes with the second electrodes, the plurality of drivers including:
a first plurality of drivers driving the first electrodes substantially simultaneously; and
a second plurality of drivers driving the plurality of second electrodes one by one in a predetermined repeating sequence.

3. The driving circuit of claim 2, wherein the compensation data compensate for brightness differences between individual picture elements, and the correction circuit uses the compensation data in generating control signals for the first plurality of drivers.

4. The driving circuit of claim 3, wherein the brightness differences include differences due to static capacitance of the picture elements, differences due to distributed resistance of the first electrodes, and differences due to distributed resistance of the second electrodes.

5. The driving circuit of claim 3, wherein the compensation data comprise one value per picture element.

6. The driving circuit of claim 2, wherein the compensation data compensate for average brightness differences between picture elements disposed on different first electrodes and the correction circuit uses the compensation data in generating control signals for the first plurality of drivers.

7. The driving circuit of claim 6, wherein the average brightness differences include differences due to static capacitance of the picture elements and differences due to distributed resistance of the second electrodes.

8. The driving circuit of claim 6, wherein the compensation data comprise one value per first electrode.

9. The driving circuit of claim 2, wherein the compensation data compensate for average brightness differences between picture elements disposed on different second electrodes.

10. The driving circuit of claim 9, wherein the correction circuit uses the compensation data in generating control signals for the first plurality of drivers.

11. The driving circuit of claim 9, wherein the correction circuit uses the compensation data in generating control signals for the second plurality of drivers.

12. The driving circuit of claim 9, wherein the average brightness differences include differences due to static capacitance of the picture elements and differences due to distributed resistance of the first electrodes.

13. The driving circuit of claim 12, wherein the compensation data comprise one value per second electrode.

14. The driving circuit of claim 2, wherein the compensation data include first compensation data compensating for average brightness differences between picture elements disposed on different first electrodes and second compensation data compensating for average brightness differences between picture elements disposed on different second electrodes, the correction circuit using the first compensation data in generating control signals for the first plurality of drivers and the second compensation data in generating control signals for the second plurality of drivers.

15. The driving circuit of claim 14, wherein the memory includes a first memory device storing the first compensation data and a second memory device storing the second compensation data.

16. The driving circuit of claim 14, wherein the first compensation data comprise one value per first electrode and the second compensation data comprise one value per second electrode.

17. The driving circuit of claim 14, wherein the correction circuit uses the first compensation data to modify driving times, driving voltages, or driving currents, and uses the second compensation data to modify driving times or driving voltages.

18. The driving circuit of claim 1, wherein the correction circuit uses the compensation data to modify driving times.

19. The driving circuit of claim 1, wherein the correction circuit uses the compensation data to modify driving voltages.

20. The driving circuit of claim 1, wherein the correction circuit uses the compensation data to modify driving currents.
